(19) United States
(12) Patent Application Publication
(10) Pub. No.: US 2011/0050541 A1
(43) Pub. Date: Mar. 3, 2011

(54) DUAL DISPLAY DEVICE

(76) Inventors: Joung-Hun SHIN, Seoul (KR); Yutaka Tanaka, Ueda-shi (JP)

(21) Appl. No.: 12/627,598

(22) Filed: Nov. 30, 2009

(30) Foreign Application Priority Data
Aug. 26, 2009 (KR) 20-2009-0011143

(51) Int. Cl. G09G 5/00

(52) U.S. Cl. 345/1.1

(57) ABSTRACT

The present invention relates to a dual display device in which angle between the two display panels can be freely varied. A dual display device includes: a first display panel having a first display screen; a second display panel having a second display screen; and a connecting frame which connecting the first display panel and the second display panel such that the first display panel and the second display panel can be rotatable to one another so that angle between the first display screen and the second display screen can be varied.

### CROSS-REFERENCE TO RELATED APPLICATION

This application claims priority to and the benefit of Korean Utility Model Application No. 20-2009-0011143 filed in the Korean Intellectual Property Office on Aug. 26, 2009, the entire contents of which are incorporated herein by reference.

### BACKGROUND OF THE INVENTION

(a) Field of the Invention

The present invention relates to a dual display device in which angle between the two display panels can be freely varied.

(b) Description of the Related Art

Display device is an apparatus for displaying images of a computer, broad casting, or the like, and recently flat display panels such as a plasma display panel, a liquid crystal display are widely used.

Information which needs to be shown to user becomes greater, and work by using one display panel is limited, so number of users who use two display panels gradually increases.

However, in the prior art, two display panels are simply disposed near, so there is limitation in space and in order to vary angle between two display panels, it needs to move the display panel.

### SUMMARY OF THE INVENTION

The present invention has been made in an effort to provide a dual display device in which angle between two display panels can be easily regulated.

An exemplary dual display device according to an embodiment of the present invention includes: a first display panel having a first display screen; a second display panel having a second display screen; and a connecting frame which connecting the first display panel and the second display panel such that the first display panel and the second display panel can be rotatable to one another so that angle between the first display screen and the second display screen can be varied.

The connecting frame may include: a fixing member to which the first display panel and the second display panel are rotatably connected respectively in a state of being adjacent to one another; a first gear and a second gear which are engaged to one another and are respectively connected to the first display panel and the second display panel so as to rotate together with the first display panel and the second display panel; and an angle regulating member which has a pinion gear engaged with one of the first gear and the second gear and is rotatably connected to the fixing member.

The dual display device may further include a support including: a supporting member to which the fixing member is connected to be rotatable in a vertical direction; and a base member supporting the supporting member.

The base member may include: a base plate having a vertical pin; and a rotating plate which is mounted on the base plate to be rotatable around the vertical pin.

The supporting member may be connected to the rotating plate to be rotatable in a vertical direction.

### BRIEF DESCRIPTION OF THE DRAWINGS

FIG. 1 is a perspective view of a dual display device according to an embodiment of the present invention.

FIG. 2 is an exploded perspective view of a dual display device according to an embodiment of the present invention.

FIG. 3 is a side elevational view of a dual display device according to an embodiment of the present invention.

FIG. 4 is an enlarged view of portion “A” in FIG. 3.

FIG. 5 is a drawing showing a first gear, a second gear and a pinion gear of a dual display device according to an embodiment of the present invention.

FIG. 6 is a drawing showing angle changing operation of a dual display device according to an embodiment of the present invention.

### DETAILED DESCRIPTION OF THE EMBODIMENTS

Exemplary embodiment of the present invention will hereinafter be described in detail with reference to the drawing.

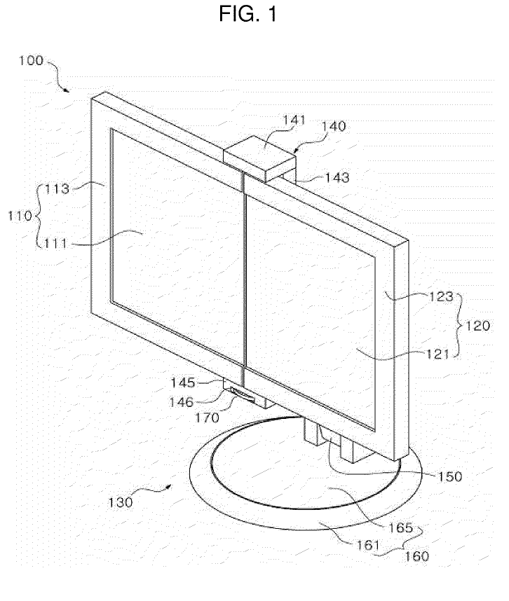

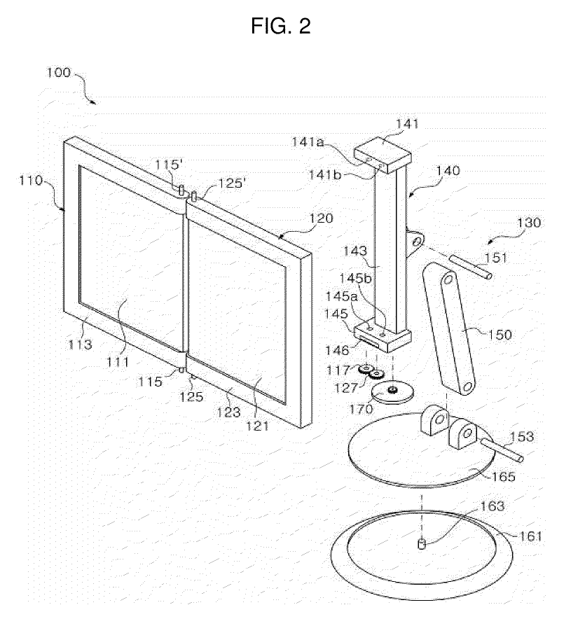

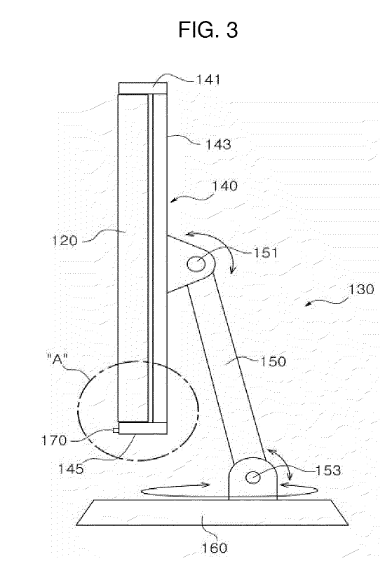

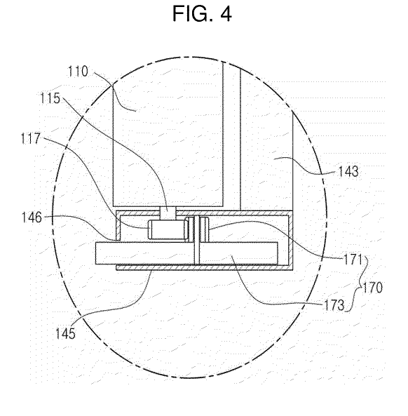

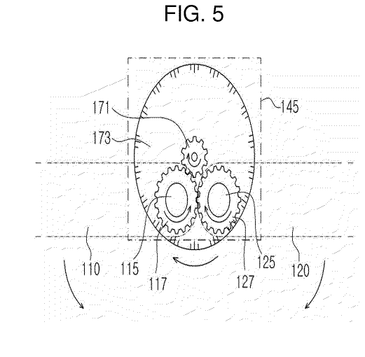

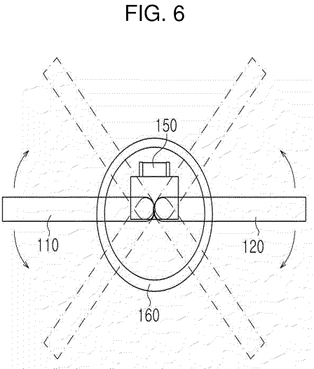

FIG. 1 is a perspective view of a dual display device according to an embodiment of the present invention, FIG. 2 is an exploded perspective view of a dual display device according to an embodiment of the present invention, FIG. 3 is a side elevational view of a dual display device according to an embodiment of the present invention, FIG. 4 is an enlarged view of portion “A” in FIG. 3, FIG. 5 is a drawing showing a first gear, a second gear and a pinion gear of a dual display device according to an embodiment of the present invention, and FIG. 6 is a drawing showing angle changing operation of a dual display device according to an embodiment of the present invention.

First, as shown in FIG. 1 and FIG. 2, a dual display device 100 according to an embodiment of the present invention includes a first display panel 110 and a second display panel 120.

The first and the second display panels 110 and 120 may be any conventional display panel which can display images such as computer image, television image, or the like.

The first display panel 110 and the second display panel 120 may includes a first bezel 113 and a second bezel 123 and a first display screen 111 and a second display screen 121, respectively.

The bezels 113 and 123 may be formed to enclose the display screens 111 and 121.

Meanwhile, in case that the first display panel 110 and the second display panel 120 are liquid crystal display panels, since continuity in image display can be deteriorated by width of the bezels 113 and 123 at a region where the first display panel 110 and the second display panel 120 contact one another, portions of the bezels 113 and 123 which contact one another can be removed to enhance continuity of image display. At this time, the liquid display panel can be cut by any conventional cutting technology known in the art.

The first display panel 110 and the second display panel 120 may display divided one image together as well as may display different images.

The dual display device 100 according to an embodiment of the present invention may include a connecting frame 130.

The connecting frame 130 connects the first display panel 110 and the second display panel 120 such that the first display panel 110 and the second display panel 120 can be rotatable to one another so that angle between the first display screen 111 and the second display screen 121 can be varied.

The connecting frame 130 includes a fixing member 140 which is configured such that the first display panel 110 and the second display panel 120 are rotatably connected respectively thereto in a state of being adjacent to one another.

In more detail, the fixing member 140 may include a connecting part 143 which is extended in a vertical direction, and an upper coupling part 141 and a lower coupling part 145 which are formed at an upper end and a lower end of the connecting part 143 respectively.

As shown in the drawing, the upper coupling part 141 and the lower coupling part 145 may have a shape of a rectangular plate respectively.

As shown in FIG. 2, upper hinges 115′ and 125′ are provided at upper surfaces of the first display panel 110 and the second display panel 120, and lower hinges 115 and 125 are provided at corresponding lower surfaces thereof. Furthermore, upper hinge holes 141a and 141b and lower hinge holes 145a and 145b are respectively formed at a lower surface of the upper coupling part 141 and an upper surface of the lower coupling part 145 of the fixing member.

The upper hinges 115′ and 125′ of the first display panel 110 and the second display panel 120 are rotatably inserted into the upper hinge holes 141a and 141b of the upper coupling part 141, and the lower hinges 115 and 125 of the first display panel 110 and the second display panel 120 are rotatably inserted into the lower hinge holes 145a and 145b of the lower coupling part 145, so the first display panel 110 and the second display panel 120 are rotatably connected to the fixing member 140.

Further, the connecting frame 130 includes a first gear 117, a second gear 127, and an angle regulating member 170 for rotating the first display panel 110 and the second display panel 120.

As shown in the drawings, the first gear 117, the second gear 127, and the angle regulating member 170 may be provided to the lower coupling part 145 of the fixing member 140. That is, as shown in the drawings, the lower coupling part 145 is formed to have an empty space therein, and the first gear 117, the second gear 127, and the angle regulating member 170 may be disposed in this empty space.

The first gear 117 is fixed to the lower hinge 115, which is fixed to the first display panel 110, so as to rotate the first display panel 110, and the second gear 127 is fixed to the lower hinge 125, which is fixed to the second panel 120, so as to rotate the second display panel 120. For this, as shown in FIG. 4, the lower hinges 115 and 125 which are fixed to the first display panel 110 and the second display panel 120 penetrate an upper case of the lower coupling part 145 of the fixing member 140 so as to be exposed to the empty space therein, and the first gear 117 and the second gear 127 are respectively coupled lower ends thereof.

At this time, as shown in FIG. 5, the first gear 117 and the second gear 127 are disposed in a state of being engaged with one another. Accordingly, if one of the first gear 117 and the second gear 127 rotates, the other rotates together and rotation directions of the first gear 117 and the second gear 127 are opposite.

Meanwhile, the angle regulating member 170 is configured to be able to rotate the first display panel 110 and the second display panel 120 by its rotation so as to regulate angle between the first display panel 110 and the second display panel 120. For this, the angle regulating member 170 is provided with a pinion gear 171 which is engaged with one of the first gear 117 and the second gear 127, and is rotatably connected to the fixing member 140. At this time, as shown in the drawing, the angle regulating member 170 may be rotatably mounted to the lower coupling part 145 in a state of being disposed in the inner space of the lower coupling part 145 of the fixing member 140.

Although the pinion gear 171 of the angle regulating member 170 is engaged with the first gear 117 in the drawing, in another embodiment the pinion gear 171 may be engaged with the second gear 127.

At this time, the angle regulating member 170 may have a body of a circular plate shape, and the pinion gear 171 may be disposed at a center of an upper surface of the body. In addition, as shown in the drawing, a portion of the body of a circular plate of the angle regulating member 170 may extrude to the outside of the inner space of the lower coupling part 145 of the fixing member 140, a user can regulate angle between the first display panel 110 and the second display panel 120 by rotating the extruded portion of the angle regulating member 170. At this time, an opening 146 may be formed at the front of the lower coupling part 145, and a portion of the angle regulating member 170 can extrude to the outside through the opening 146.

That is, if the angle regulating member 170 rotates, the pinion gear 171 rotates together with the angle regulating member 170, and the pinion gear 171 rotates the first gear 117 and the second gear 127, so the first display panel 110 and the second display panel 120 rotate. At this time, the first gear 117 and the second gear 127 rotate in opposite directions, so the first display panel 110 and the second display panel 120 also rotate in opposite directions so that angle between first display panel 110 and the second display panel 120 can be decreased or increased.

Meanwhile, the dual display device according to an embodiment of the present invention may further include a support including a supporting member 150 and a base member 160.

Referring to FIG. 2 and FIG. 3, the fixing member 140 is connected to the supporting member 150 to be rotatable in a vertical direction. For example, the fixing member 140 is connected to an upper end of the supporting member 150 via a first hinge 151 so as to be rotatable in a vertical direction.

The base member 160 supports the supporting member 150. At this time, the supporting member 150 is connected to the base member 160 via a second hinge 153 so as to be rotatable in a vertical direction.

Meanwhile, as shown in FIG. 2 and FIG. 3, the base member 160 may include a base plate 161 and a rotating plate 165. The base plate 161 contacts the bottom ground, and the rotating plate 165 is disposed on the base plate 161. A vertical pin 163 which vertically extends from the base plate 161 is formed on the base plate 161, and the rotating plate 165 is rotatably connected to the vertical pin 163 so that the rotating plate 165 can be rotatable about the vertical pin 163. At this time, the other end of the supporting member 150 is coupled to the rotating plate 165.

As shown in FIG. 5 and FIG. 6, the first and the second display panels 110 and 120 rotate in opposite directions, so the first display panel 110 and the second display panel 120 can rotate to become more distant from one another or come near to one another.

Furthermore, the fixing member 140 which supports the first display panel 110 and the second display panel 120 is connected to the supporting member 150 to be rotatable in a vertical direction and the supporting member 150 is connected to the base member 160 to be rotatable in a vertical direction, so angle in a vertical direction of the first display panel 110 and the second display panel 120 can be freely varied. Still furthermore, the rotating plate 165 of the base member 160 is rotatably connected to the base plate 161, so angle in a horizontal direction of the first display panel 110 and the second display panel 120 can be freely varied.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the present invention, by rotating one of two display panels, the other display panel also rotates, so angle between two display panels can be easily regulated, and rotating angle of the display panel can be precisely regulated using an angle regulating member.

What is claimed is:

1. A dual display device comprising:
a first display panel having a first display screen;
a second display panel having a second display screen; and
a connecting frame which connecting the first display panel and the second display panel such that the first display panel and the second display panel can be rotatable to one another so that angle between the first display screen and the second display screen can be varied.

2. The dual display device of claim 1, wherein the connecting frame comprises:
a fixing member to which the first display panel and the second display panel are rotatably connected respectively in a state of being adjacent to one another;
a first gear and a second gear which are engaged to one another and are respectively connected to the first display panel and the second display panel so as to rotate together with the first display panel and the second display panel; and
an angle regulating member which has a pinion gear engaged with one of the first gear and the second gear and is rotatably connected to the fixing member.

3. The dual display device of claim 2 further comprising a support including:
a supporting member to which the fixing member is connected to be rotatable in a vertical direction; and
a base member supporting the supporting member.

4. The dual display device of claim 3, wherein the base member comprises:
a base plate having a vertical pin; and
a rotating plate which is mounted on the base plate to be rotatable around the vertical pin.

5. The dual display device of claim 4, wherein the supporting member is connected to the rotating plate to be rotatable in a vertical direction.
